(19) United States
(12) Patent Application Publication
(10) Pub. No.: US 2008/0165092 A1
(43) Pub. Date: Jul. 10, 2008

(54) PLASMA DISPLAY DEVICE AND METHOD OF DRIVING THE SAME

(76) Inventor: Luck-hyun Kim, Suwon (KR)

Correspondence Address: CHRISTIE, PARKER & HALE, LLP, PO BOX 7068, PASADENA, CA, 91109-7068, US

(21) Appl. No.: 11/968,617

(22) Filed: Jan. 2, 2008

(30) Foreign Application Priority Data
Jan. 4, 2007 (KR) 10-2007-0001117

(51) Int. Cl. G09G 3/28

(52) U.S. Cl. 345/68

(57) ABSTRACT

A three electrode AC plasma display device including a plasma display panel and an improved energy recovery circuit. The energy recovery circuit uses resonance to efficiently drive a scan electrode and a sustain electrode with alternating sustain pulses to create a sustain discharge in a discharge cell. A panel capacitor lies between the sustain electrode and the scan electrode. According to one embodiment, a first inductor is coupled to the scan electrode and a second inductor is coupled to the sustain electrode. Four switches control connections within the energy recovery circuit. The first inductor creates a resonant circuit with the panel capacitor to transfer the sustain voltage from the scan electrode to the sustain electrode. The second inductor creates a resonant circuit with the panel capacitor to transfer the sustain voltage back from the sustain electrode to the scan electrode.

### CROSS-REFERENCE TO RELATED APPLICATION

This application claims priority to and the benefit of Korean Patent Application No. 10-2007-0001117, filed on Jan. 4, 2007, in the Korean Intellectual Property Office, the entire content of which is incorporated herein by reference.

### BACKGROUND

1. Field of the Invention

The present invention relates to a plasma display device including a plasma display panel and an energy recovery circuit, and a method of driving the same.

2. Discussion of Related Art

A plasma display panel (hereinafter, referred to as a ‘PDP’) generally displays an image by irradiating light-emitting phosphors with ultraviolet light generated by a discharge of an inert mixed gas. This PDP can easily be made thin and large, and with the recent development of the relevant technology it can have an excellent image quality. Particularly, a three-electrode AC surface discharge type PDP has an advantage of a relatively low driving voltage and a relatively long product lifespan, as a wall charge is accumulated on a surface in discharging and electrodes are protected from sputtering caused by discharging.

FIG. 1 shows an array of electrodes of a conventional three-electrode AC-type PDP.

Referring to FIG. 1, the electrodes of the PDP include a plurality of address electrodes A1, A2, . . . Am extending in a column direction and a plurality of scan electrodes Y1, Y2, . . . Yn and sustain electrodes X1, X2, . . . Xn extending in a row direction.

Such an AC type PDP is generally operated by a control circuit that divides each image frame into a plurality of subfields, each having a reset period, an address period and a sustain period, and drives the electrodes of the PDP with appropriate signals to display an image.

During the reset period, the state of each pixel is initialized so that the addressing operation of each pixel 12 can be smoothly performed.

During the address period, wall charge is accumulated by applying an address voltage to the pixel 12, which is selected in order to selectively make the pixel 12 turn on in a panel.

During the sustain period, a discharge is generated by applying sustain pulses for actually displaying an image on the pixel 12 that was selectively addressed. In performing the sustain discharge operation of such an AC-type PDP, sustain pulses at a high voltage of about 200 V may alternately be applied to the sustain electrode X and the scan electrode Y, and thus a considerable amount of energy may be lost. Therefore, in order to reduce or minimize power required in performing a sustain discharge, an energy recovery circuit is constituted and used. The energy recovery circuit recovers the energy stored in a parasitic capacitance between the scan electrodes Y1, Y2, . . . Yn and the sustain electrodes X1, X2, . . . Xn and then uses the recovered energy to create a driving voltage at the time of the next discharge.

FIG. 2 shows a circuit view of a portion of a conventional plasma display device.

Referring to FIG. 2, the plasma display device includes a discharge cell 10 and an energy recovery circuit 20.

The discharge cell 10 includes an equivalent capacitance called a panel capacitor Cp, representing a parasitic capacitance between a scan electrode Y and a sustain electrode X. The sustain discharge occurs in the panel capacitor Cp, between the scan electrode Y and the sustain electrode X, using the sustain voltage supplied in part from the energy recovery circuit 20.

In a conventional plasma display device, an energy recovery circuit such as item 20 in FIG. 2 is coupled to both the scan electrode Y and sustain electrode X to alternately supply the sustain pulses to either side of the panel capacitor Cp. The energy recovery circuits 20 respectively coupled to the scan electrode Y and the sustain electrode X are installed to be symmetrical to each other so that the energy recovery circuit 20 coupled to either one of the scan electrode Y or the sustain electrode X is like the one illustrated in FIG. 2.

The energy recovery circuit 20 includes a first switch SW1, a second switch SW2, a third switch SW3, a fourth switch SW4, a voltage recovery capacitor Cs, an inductor L, a first diode D1, and a second diode D2. The voltage recovery capacitor Cs should have a capacitance capable of charging ½ of a sustain voltage (Vs/2).

The first switch SW1 is coupled between the voltage recovery capacitor Cs and the inductor L. The first switch SW1 is turned on when a voltage is supplied from the voltage recovery capacitor Cs to the panel capacitor Cp.

The second switch SW2 is coupled between the voltage recovery capacitor Cs and the inductor L. The second switch SW2 is turned on when a voltage is recovered from the panel capacitor Cp to the voltage recovery capacitor Cs.

The third switch SW3 is connected between a sustain voltage source Vs and the panel capacitor Cp. The third switch SW3 is turned on when the sustain voltage Vs is supplied to the panel capacitor Cp.

The fourth switch SW4 is connected between the panel capacitor Cp and a second ground voltage source GND2. The fourth switch SW4 is turned on when the ground voltage is supplied to the panel capacitor Cp.

The voltage recovery capacitor Cs is connected between a node coupling the first switch SW1 and the second switch SW2, and a third ground voltage source GND3. And, the voltage recovery capacitor Cs transfers a voltage (e.g., a predetermined voltage) to the panel capacitor Cp through the first switch SW1, or recovers a voltage (e.g., a predetermined voltage) from the panel capacitor Cp through the second switch SW2.

The inductor L is coupled between a node coupling the first switch SW1 to the second switch SW2, and the panel capacitor Cp, to form a resonant circuit with the panel capacitor Cp.

The first diode D1 is connected to the first switch SW1, and the second diode D2 is connected to the second switch SW2, preventing reverse currents from flowing to each element.

The energy recovery operation of the plasma display device having the above structure will be described as follows. First, it will be assumed that the panel capacitor Cp is charged with voltage of OV and the voltage recovery capacitor Cs is charged with voltage as much as Vs/2.

When the first switch SW1 is turned on, a current path from the voltage recovery capacitor Cs, through the first switch SW1 and the inductor L, and to the panel capacitor Cp is formed. In this case, because the inductor L and the panel capacitor Cp form the resonant circuit, the panel capacitor Cp is approximately supplied with the sustain voltage Vs. That is, the panel capacitor Cp is approximately charged with the sustain voltage Vs while the first switch SW1 is turned on.

After the panel capacitor Cp is charged with the sustain voltage Vs, the third switch SW3 is turned on. When the third switch SW3 is turned on, the sustain voltage Vs is supplied to the panel capacitor Cp. If the sustain voltage Vs is supplied to the panel capacitor Cp as above, the voltage of the panel capacitor Cp is stably maintained at the sustain voltage Vs so that a stable sustain discharge is generated accordingly.

And, since the panel capacitor Cp is approximately charged with the sustain voltage Vs while the first switch SW1 is turned on, the energy supplied from a sustain voltage source Vs is reduced or minimized when the third switch SW3 is turned on, making it possible to reduce power consumption accordingly.

Thereafter, the first switch SW1 and the third switch SW3 are turned off, and the second switch SW2 is turned on. When the second switch SW2 is turned on, a current path from the panel capacitor Cp, through the inductor L and the second switch SW2, and to the voltage recovery capacitor Cs is formed. Therefore, the voltage charged in the panel capacitor Cp is recovered to the voltage recovery capacitor Cs. In this case, the voltage recovery capacitor Cs is charged with a voltage as much as Vs/2.

Next, the second switch SW2 is turned off and the fourth switch SW4 is turned on. Accordingly, a current path is formed between the panel capacitor Cp and the second ground voltage source GND2 so that the voltage of one side electrode Y or X (i.e., the one that is coupled to this energy recovery circuit 20) of the panel capacitor Cp is dropped to ground voltage.

However, in the energy recovery circuit 20 as described above, because one such circuit is coupled to each of the respective sustain electrode X and scan electrode Y, many circuit parts are mounted and the manufacturing costs are increased accordingly. Also, in the prior art, the voltage of the panel capacitor Cp is raised to the sustain voltage Vs by using the voltage of Vs/2. In this case, the voltage of the panel capacitor Cp cannot completely be raised to the sustain voltage Vs due to parasitic components, etc. of the circuit so that switching loss (hard switching) may be generated in the third switch SW3.

### SUMMARY OF THE INVENTION

The present invention is directed to provide a plasma display device including a plasma display panel (PDP) and an energy recovery circuit, and a method of driving the same, capable of reducing the number of circuit elements.

A plasma display device having features of an exemplary embodiment of the present invention includes a PDP having a plurality of sustain electrodes, a plurality of scan electrodes. A panel capacitor lies between a sustain electrode among the sustain electrodes, and a scan electrode among the scan electrodes. The plasma display device further includes an energy recovery circuit for alternately supplying a sustain voltage to the sustain electrode and the scan electrode. The energy recovery circuit includes a first voltage source for supplying a first voltage, and a second voltage source for supplying a second voltage. A first switch coupled between the scan electrode and the first voltage source selectively transfers the first voltage to the scan electrode. A second switch coupled between the scan electrode and the second voltage source selectively transfers a second voltage to the scan electrode. A third switch coupled between the first voltage source and the sustain electrode selectively transfers the first voltage to the sustain electrode. A fourth switch coupled between the sustain electrode and the second voltage source selectively transfers the second voltage to the sustain electrode. A first inductor is coupled between a node coupling the second switch and the second voltage source, and the scan electrode. A second inductor is coupled between a node coupling the fourth switch and the second voltage source, and the sustain electrode.

A method of driving a plasma display panel having features of an exemplary embodiment of the present invention includes an energy recovery circuit for alternately supplying a sustain voltage to a sustain electrode and a scan electrode. The method includes supplying the sustain voltage to the sustain electrode to while transferring a voltage of the scan electrode to the sustain electrode; maintaining the scan electrode at a ground potential while maintaining the sustain electrode at the sustain voltage; supplying the sustain voltage to the scan electrode while transferring a voltage of the sustain electrode to the scan electrode; and maintaining the sustain electrode at the ground potential while maintaining the scan electrode at the sustain voltage.

### BRIEF DESCRIPTION OF THE DRAWINGS

The accompanying drawings, together with the specification, illustrate exemplary embodiments of the present invention, and together with the description, serve to explain the principles of the present invention.

FIG. 1 schematically shows an array of electrodes for explaining a conventional plasma display panel;

FIG. 2 is an energy recovery circuit diagram of a conventional plasma display device;

FIG. 3 is an energy recovery circuit diagram of a plasma display device according to an exemplary embodiment of the present invention;

FIG. 4 is a timing diagram for operating the circuit as shown in FIG. 3; and

FIG. 5 is a simulation diagram according to FIGS. 3 and 4.

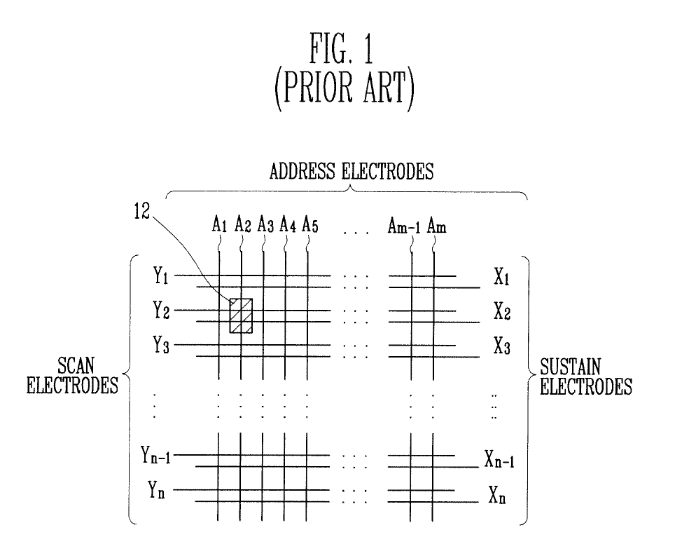

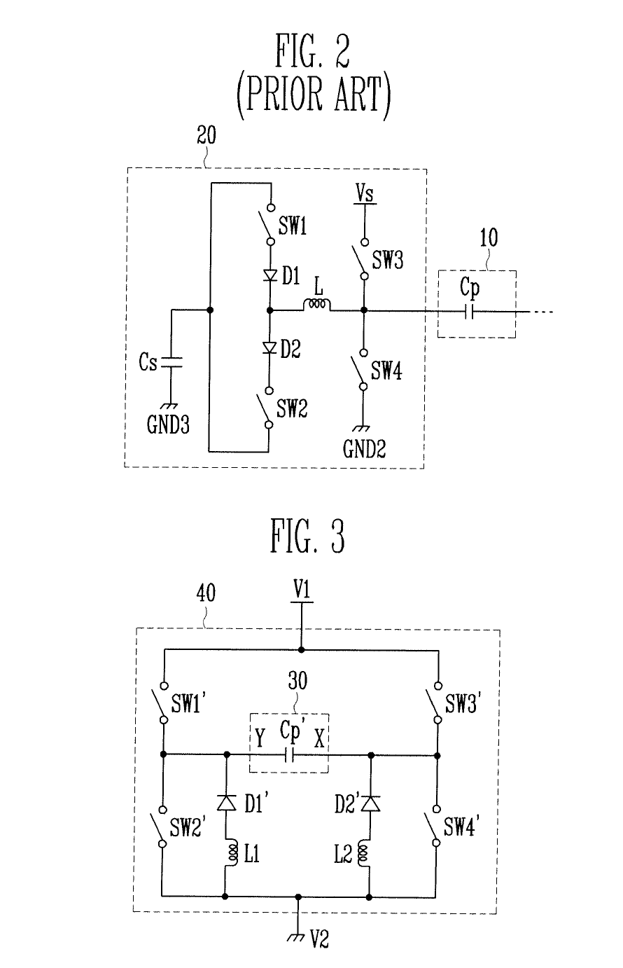

### DETAILED DESCRIPTION OF EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being connected or coupled to another element, it can be directly connected or coupled to the another element or be indirectly connected or coupled to the another element with one or more intervening elements interposed therebetween. Like reference numerals designate like elements throughout the specification.

Hereinafter, exemplary embodiments according to the present invention will be described with reference to the accompanying drawings.

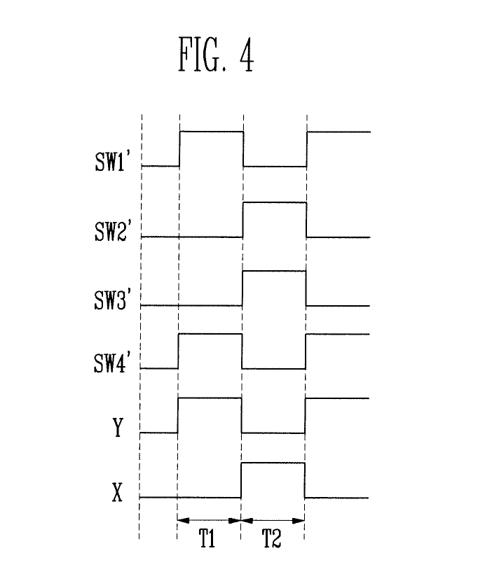

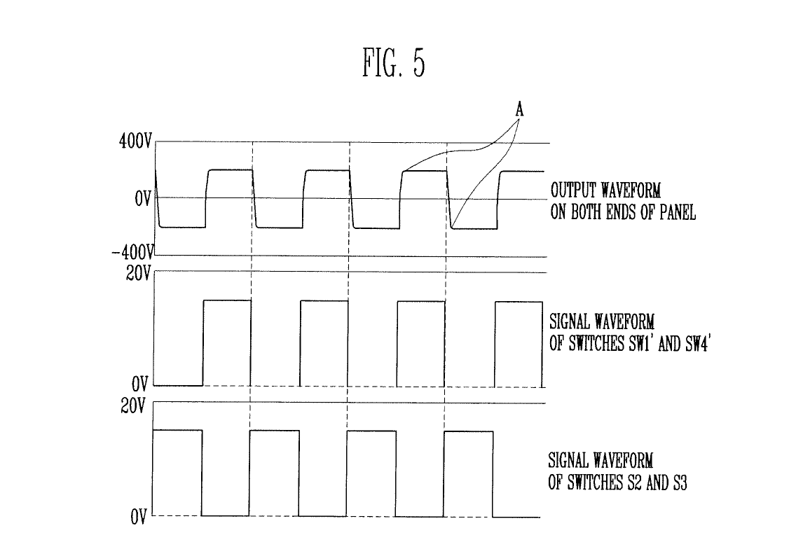

FIG. 3 is a circuit diagram showing one example of an energy recovery circuit 40 of a plasma display device according to an embodiment of the present invention; FIG. 4 is a timing diagram for operating the circuit as shown in FIG. 3; and FIG. 5 is a simulation diagram according to FIGS. 3 and 4.

Referring to FIG. 3, a plasma display device according to an embodiment of the present invention includes a discharge cell 30 and an energy recovery circuit 40. While only one X electrode and only one Y electrode are shown in FIG. 3 for ease of description, in practice, multiple panel capacitors formed by respective X and Y electrodes are coupled to the energy recovery circuit 40.

The discharge cell 30 includes a panel capacitor Cp′ representing a parasitic capacitance between a scan electrode Y and a sustain electrode X. The discharge cell 30 displays an image by repeatedly charging/discharging the panel capacitor Cp′ with a suitable voltage (e.g., a predetermined voltage).

The energy recovery circuit 40 is common to the scan electrode Y and the sustain electrode X, and alternately supplies a first voltage V1 to the scan electrode Y and the sustain electrode X. In the illustrated embodiment, the scan electrode Y and the sustain electrode X share one energy recovery circuit 40, making it possible to reduce the number of circuit elements as compared to the prior art.

The energy recovery circuit 40 includes a first switch SW1′, a second switch SW2′, a third switch SW3′, a fourth switch SW4′, a first inductor L1, a second inductor L2, a first diode D1′, and a second diode D2′.

The first switch SW1′ is coupled between a first voltage source V1 and the scan electrode Y of the panel capacitor Cp′ to selectively transfer the first voltage V1 to the scan electrode Y.

The second switch SW2′ is coupled between the scan electrode Y and a second voltage source V2 to selectively transfer the second voltage V2 to the scan electrode Y.

The third switch SW3′ is coupled between the first voltage source V1 and the sustain electrode X of the panel capacitor Cp′ to selectively transfer the first voltage V1 to the sustain electrode X.

The fourth switch SW4′ is coupled between the sustain electrode X and the second voltage source V2 to selectively transfer the second voltage V2 to the sustain electrode X.

The first inductor L1 is coupled between the scan electrode Y and a node coupling the second switch SW2′ and the second voltage source V2. The first inductor L1 forms a resonant circuit with the panel capacitor Cp′ when the fourth switch SW4′ is turned on.

The second inductor L2 is connected between the sustain electrode X of the panel capacitor Cp′ and a contact of the fourth switch SW4′ and the second voltage source V2. The second inductor L2 as above forms a resonant circuit with the panel capacitor Cp′ when the second switch SW2′ is turned on.

The first diode D1′ and the second diode D2′ are connected in series to the first inductor L1 and the second inductor L2, respectively, so that the diodes control the flow of current. The first diode D1′ prevents the voltage applied to the scan electrode Y from being supplied to the second voltage source V2. The second diode D2′ prevents the voltage applied to the sustain electrode X from being supplied to the second voltage source V2.

Referring to FIG. 4, a method of driving a plasma display panel according to an exemplary embodiment of the present invention will be described as follows. In the following description, it will be assumed that the first voltage V1 and the second voltage V2 were previously applied to the sustain electrode X and the scan electrode Y, respectively. Here, the first voltage V1 is assumed to be the sustain voltage Vs, which is positive voltage, and the second voltage V2 is assumed to be the ground voltage. However, the present invention is not limited thereto.

First, in a first period T1, the first switch SW1′ and the fourth switch SW4′ are turned on. When the fourth switch SW4′ is turned on, a current path is formed from the sustain electrode X, through the fourth switch SW4′ and the first inductor L1, and to the scan electrode Y of the panel capacitor Cp′. Here, because the first inductor L1 and the panel capacitor Cp′ form a resonant circuit, the voltage emitted from the sustain electrode X is supplied to the scan electrode Y of the panel capacitor Cp′. That is, when the fourth switch SW4′ is turned on, the voltage of the sustain electrode X of the panel capacitor Cp′ is recovered so that the voltage of the scan electrode Y of the panel capacitor Cp′ is raised (the operations of charging and discharging are concurrently generated in the panel capacitor Cp′).

More specifically, the voltage outputted from the sustain electrode X of the panel capacitor Cp′ when the fourth switch SW4′ is turned on is raised to a voltage corresponding to twice the sustain voltage Vs (that is, the first voltage V1) using the resonant circuit, and accordingly, a suitable voltage (e.g., a predetermined voltage) is supplied to the scan electrode Y of the panel capacitor Cp′. Here, because the first switch SW1′ maintains a turn on state, the voltage of the scan electrode Y of the panel capacitor Cp′ is not raised to the voltage more than the first voltage V1. And, because the first switch SW1′ maintains a turn on state, the first voltage V1 is stably supplied to the scan electrode Y of the panel capacitor Cp′, making it possible to stably generate the sustain discharge. Meanwhile, because the fourth switch SW4′ maintains a turn on state, the sustain electrode X of the panel capacitor Cp′ is dropped to the second voltage V2.

As described above, in an exemplary embodiment of the present invention the voltage emitted from one side electrode (for example, X) of the panel capacitor Cp′ is instantly raised using the resonant circuit and at the same time, the voltage is recovered to the other side electrode (for example, Y) thereof, making it possible to reduce the power consumption. And, in an exemplary embodiment of the present invention, when the voltage is recovered to the other side electrode thereof, the connection state of the other side electrode thereof to the first voltage source V1 is maintained, making it possible to prevent the other side electrode thereof from being raised to a voltage more than the voltage of the first voltage source V1. Also, in an exemplary embodiment of the present invention, when the voltage is recovered from one side electrode of the panel capacitor Cp′, the voltage of the other side electrode thereof is stably raised to the voltage of the first voltage source V1. Therefore, the present invention can reduce switching loss due to a hard switching.

In a second period T2, the first switch SW1′ and the fourth switch SW4′ are turned off, and the second switch SW2′ and the third switch SW3′ are turned on. At this time, a current path from the scan electrode Y of the panel capacitor Cp′, through the second switch SW2′ and the second inductor L2, to the sustain electrode X is formed. Here, the panel capacitor Cp′ and the second inductor L2 form a resonant circuit.

Therefore, the voltage discharged from the scan electrode Y of the panel capacitor Cp′ is instantly raised to the voltage corresponding to twice the first voltage V1, and at the same time, is supplied to the sustain electrode X of the panel capacitor Cp′. And, because the sustain electrode X of the panel capacitor Cp′ is connected to the first voltage source V1, the sustain electrode X of the panel capacitor Cp′ stably maintains the voltage of the first voltage source V1. Meanwhile, when the second switch SW2′ is turned on, the scan electrode Y of the panel capacitor Cp′ is dropped to the voltage of the second voltage source V2.

FIG. 5 shows the result of a simulation of the exemplary embodiment of an energy recovery circuit 40 as shown in FIG. 3.

Referring to FIG. 5, an exemplary embodiment of the present invention can stably supply the sustain voltage Vs without distortion of a waveform as shown at points “A” so that the sustain discharges are stably generated.

One aspect of the plasma display panel and the driving method thereof having features of an exemplary embodiment of the present invention, is that the sustain electrode X and the scan electrode Y share one energy recovery circuit 40 so that the number of circuit elements can be reduced and the manufacturing costs thereof can be reduced accordingly. According to another aspect of an exemplary embodiment of the present invention, when energy is recovered from one side electrode of the panel capacitor Cp′ to the other side electrode thereof, the voltage of the other side electrode thereof is stably raised to the sustain voltage Vs, making it possible to reduce a switching loss.

Although a few exemplary embodiments of the present invention have been shown and described, it would be appreciated by those skilled in the art that the invention is not limited to the disclosed embodiments, but, on the contrary, changes might be made to these embodiments without departing from the principles and spirit of the invention, the scope of which is defined in the claims and their equivalents.

What is claimed is:

1. A plasma display device comprising:
a plasma display panel comprising a plurality of sustain electrodes and a plurality of scan electrodes, a sustain electrode among the sustain electrodes and a scan electrode among the scan electrodes forming a panel capacitor;
an energy recovery circuit adapted to alternately apply a sustain voltage to the sustain electrode and the scan electrode, the energy recovery circuit comprising:
a first switch coupled between the scan electrode and a first voltage source to selectively transfer a first voltage of the first voltage source to the scan electrode;
a second switch coupled between the scan electrode and a second voltage source to selectively transfer a second voltage of the second voltage source to the scan electrode;
a third switch coupled between the first voltage source and the sustain electrode to selectively transfer the first voltage to the sustain electrode;
a fourth switch coupled between the sustain electrode and the second voltage source to selectively transfer the second voltage to the sustain electrode;
a first inductor coupled between a node coupling the second switch and the second voltage source, and the scan electrode; and
a second inductor coupled between a node coupling the fourth switch and the second voltage source, and the sustain electrode.

2. The plasma display device as claimed in claim 1, wherein the first voltage is a sustain voltage sufficient to generate a discharge between the sustain electrode and the scan electrode, and the second voltage is a ground voltage.

3. The plasma display device as claimed in claim 2, wherein the energy recovery circuit is adapted such that when the first switch and the fourth switch are turned on, a voltage from the sustain electrode is transferred to the scan electrode via a resonant circuit comprising the first inductor and the panel capacitor.

4. The plasma display device as claimed in claim 2, wherein the energy recovery circuit is adapted such that when the second switch and the third switch are turned on, a voltage from the scan electrode is transferred to the sustain electrode via a resonant circuit comprising the second inductor and the panel capacitor.

5. The plasma display device as claimed in claim 1, wherein the energy recovery circuit further comprises:
a first diode coupled between the first inductor and the scan electrode; and
a second diode coupled between the second inductor and the sustain electrode.

6. The plasma display device as claimed in claim 1, wherein the first switch and the fourth switch alternately operate with the second switch and the third switch.

7. A method of driving a plasma display panel including a sustain electrode and a scan electrode, the method comprising:
supplying a sustain voltage to the sustain electrode by transferring a voltage of the scan electrode to the sustain electrode;
maintaining the scan electrode at a ground potential while maintaining the sustain electrode at the sustain voltage;
supplying the sustain voltage to the scan electrode by transferring a voltage of the sustain electrode to the scan electrode;
maintaining the sustain electrode at the ground potential while maintaining the scan electrode at the sustain voltage.

8. A method of driving a plasma display device comprising a plasma display panel and a control circuit, the plasma display panel comprising a scan electrode and a sustain electrode that form a panel capacitor, wherein the control circuit comprises a first inductor for forming a first resonant circuit with the panel capacitor and a second inductor for forming a second resonant circuit with the panel capacitor, the method comprising:
shorting out the first inductor to suppress the first resonant circuit;
transferring energy stored as a first voltage across the panel capacitor to energy stored as a first current in the second inductor;
using the energy stored as the first current in the second inductor to charge the panel capacitor with a second voltage of an opposite polarity from the first voltage; and
clamping the panel capacitor at the second voltage.

9. The method of claim 8, further comprising:
shorting out the second inductor to suppress the second resonant circuit;
transferring energy stored as the second voltage across the panel capacitor to energy stored as a second current in the first inductor;
using the energy stored as the second current in the first inductor to charge the panel capacitor with the first voltage of an opposite polarity from the second voltage; and
clamping the panel capacitor at the first voltage.
